(19) United States
(12) Patent Application Publication
(10) Pub. No.: US 2025/0238705 A1
(43) Pub. Date: Jul. 24, 2025

(54) MACHINE LEARNING AND RULES-BASED RECOMMENDATIONS FOR USER INTERFACE WORKFLOWS

(71) Applicant: Optum, Inc., Minnetonka, MN (US)

(72) Inventors: Anders Wolf, Woodbury, MN (US); Vaishnavi V. G, Delhi (IN); Apoorva Nigam, Lucknow (IN); Abhishek Kumar Raghuvanshi, Gurugram (IN)

(21) Appl. No.: 18/415,903

(22) Filed: Jan. 18, 2024

(51) Int. Cl. G06N 20/00

(52) U.S. Cl. CPC G06N 20/00

(57) ABSTRACT

Various embodiments of the present disclosure provide machine learning and rules-based recommendations for user interface workflows. In one example, an embodiment provides for generating a set of recommendation data objects for a user identifier associated with a user interface based on a set of predefined rules associated with input data provided via a user interface workflow associated with the user interface, generating a ranked version of the set of recommendation data objects using a machine learning model, and initiating a rendering of a set of selectable graphical elements via the user interface based on the ranked version of the set of recommendation data objects.

### BACKGROUND

Various embodiments of the present disclosure address technical challenges related to rules-based recommendation engines for user interfaces. Existing rules-based recommendation engines are ill-suited to accurately, efficiently, and/or reliably provide recommendations for user interface workflows in a consumable manner. This results in wasted computing resources for user interface workflows where certain recommendation results are generated but presented via a user interface behind other less relevant recommendation results. For example, traditional user interfaces provide static recommendation results in a list form based on rules-based logic for input provided via a user interface workflow. However, the list of recommendation results lack personalized information for a user, resulting in vast expenditures of time and computing resources as the user interacts with multiple irrelevant recommendation results via the user interface before identifying a sufficient recommendation result.

### BRIEF SUMMARY

In general, various embodiments of the present disclosure provide methods, apparatus, systems, computing devices, computing entities, and/or the like for providing machine learning using map representations of categorical data to provide classification predictions. To do so, at least a first map representation of a first categorical input feature set for categorical data may be generated based on a first coding standard. Additionally, at least a second map representation of a second categorical input feature set for the categorical data may be generated based on a second coding standard. The first map representation may map presence of one or more first predictive codes for the first coding standard in the categorical data. The second map representation may map presence of one or more second predictive codes for the second coding standard in the categorical data. Using at least one machine learning model, a prediction output based on the first map representation and the second map representation. Furthermore, the performance of one or more prediction-based actions may be initiated based on the prediction output.

In some embodiments, a computer-implemented method includes generating, by one or more processors, a set of recommendation data objects for a user identifier associated with a user interface based on a set of predefined rules associated with input data provided via a user interface workflow associated with the user interface. In some embodiments, the computer-implemented method additionally or alternatively includes generating, by the one or more processors and using a machine learning model, a ranked version of the set of recommendation data objects based on (i) the input data, (ii) a user behavior data associated with the user identifier, and (iii) a domain features set associated with respective domain classifications for the set of recommendation data objects. In some embodiments, the computer-implemented method additionally or alternatively includes initiating, by the one or more processors and via the user interface, a rendering of a set of selectable graphical elements based on the ranked version of the set of recommendation data objects.

In some embodiments, a computing system includes memory and one or more processors communicatively coupled to the memory. In some embodiments, the one or more processors are configured to generate a set of recommendation data objects for a user identifier associated with a user interface based on a set of predefined rules associated with input data provided via a user interface workflow associated with the user interface. In some embodiments, the one or more processors are additionally or alternatively configured to generate, using a machine learning model, a ranked version of the set of recommendation data objects based on (i) the input data, (ii) a user behavior data associated with the user identifier, and (iii) a domain features set associated with respective domain classifications for the set of recommendation data objects. In some embodiments, the one or more processors are additionally or alternatively configured to initiate, via the user interface, a rendering of a set of selectable graphical elements based on the ranked version of the set of recommendation data objects.

In some embodiments, one or more non-transitory computer-readable storage media include instructions that, when executed by one or more processors, cause the one or more processors to generate a set of recommendation data objects for a user identifier associated with a user interface based on a set of predefined rules associated with input data provided via a user interface workflow associated with the user interface. In some embodiments, the instructions, when executed by the one or more processors, additionally or alternatively cause the one or more processors to generate, using a machine learning model, a ranked version of the set of recommendation data objects based on (i) the input data, (ii) a user behavior data associated with the user identifier, and (iii) a domain features set associated with respective domain classifications for the set of recommendation data objects. In some embodiments, the instructions, when executed by the one or more processors, additionally or alternatively cause the one or more processors to initiate, via the user interface, a rendering of a set of selectable graphical elements based on the ranked version of the set of recommendation data objects.

### BRIEF DESCRIPTION OF THE DRAWINGS

FIG. 1 provides an example overview of an architecture in accordance with one or more embodiments of the present disclosure.

FIG. 2 provides an example machine learning computing recommendation entity in accordance with one or more embodiments of the present disclosure.

FIG. 3 provides an example external computing entity in accordance with one or more embodiments of the present disclosure.

FIG. 4 provides an example system that provides rules-based recommendations associated with a rules engine in accordance with one or more embodiments of the present disclosure.

FIG. 5 provides an example system that provides machine learning associated with a machine learning engine in accordance with one or more embodiments of the present disclosure.

FIG. 6 provides another example system that provides machine learning associated with a machine learning engine in accordance with one or more embodiments of the present disclosure.

FIG. 7 provides an example system that provides for prediction-based actions and/or visualizations in accordance with one or more embodiments of the present disclosure.

FIG. 8 provides an example user interface related to prediction-based visualizations in accordance with one or more embodiments of the present disclosure.

FIG. 9 is a flowchart diagram of an example process for generating recommendation data objects for a user interface using machine learning and rules-based logic in accordance with one or more embodiments of the present disclosure.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that the present disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component May be stored as a file or other data storage construct. Software components of a similar type or functionally related may be stored together, such as, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In some embodiments, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

### II. Example Framework

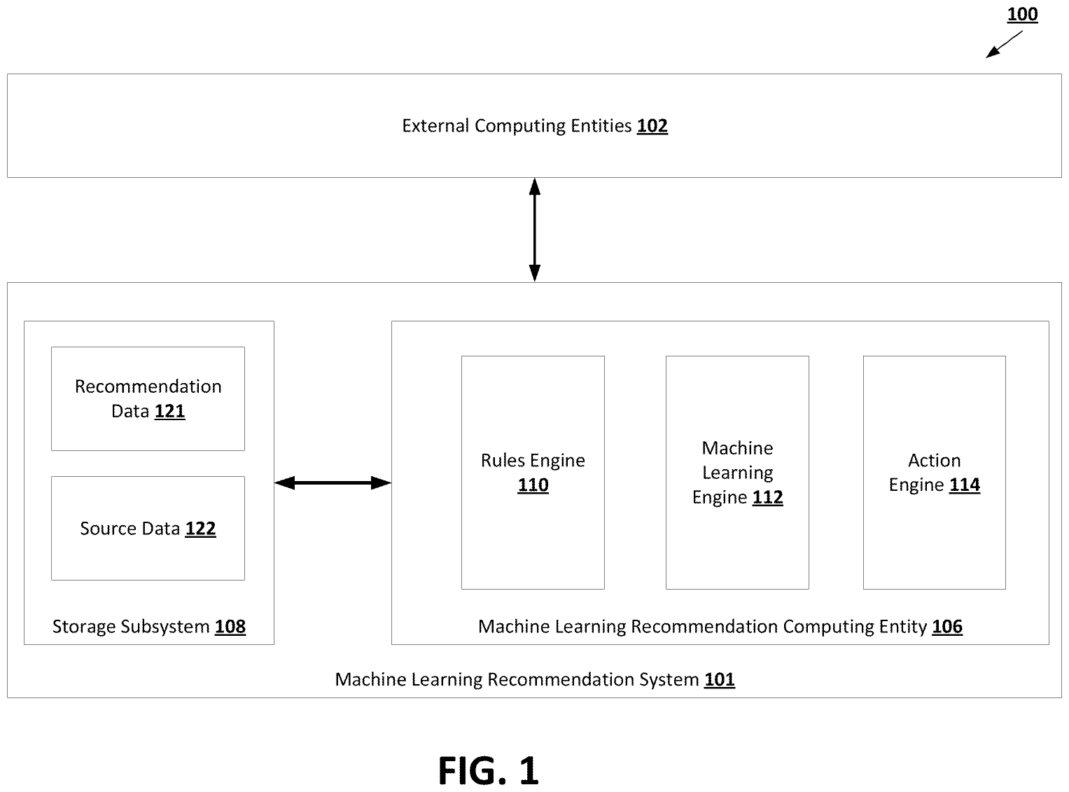

FIG. 1 provides an example overview of an architecture 100 that can be used to practice embodiments of the present disclosure. The architecture 100 includes a machine learning recommendation system 101 and one or more external computing entities 102. For example, at least some of the one or more external computing entities 102 can provide inputs to the machine learning recommendation system 101. Additionally or alternatively, at least some of the one or more external computing entities 102 can receive decision outputs, task outputs and/or action outputs from the machine learning recommendation system 101 in response to providing the inputs. As another example, at least some of the external computing entities 102 can provide one or more data streams and/or one or more batch loads to the machine learning recommendation system 101 and request performance of particular prediction-based actions in accordance with the provided one or more data streams and/or one or more batch loads. As a further example, at least some of the external computing entities 102 can provide training data to the machine learning recommendation system 101 and request training of one or more machine learning models in accordance with the provided training data. In some of the noted embodiments, the machine learning recommendation system 101 can be configured to transmit parameters, hyper-parameters, and/or weights of a trained machine learning model to the external computing entities 102.

In some embodiments, the machine learning recommendation system 101 can include a machine learning recommendation computing entity 106. The machine learning recommendation computing entity 106 and the external computing entities 102 can be configured to communicate over a communication network (not shown). The communication network can include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

Additionally, in some embodiments, the machine learning recommendation system 101 can include a storage subsystem 108. The machine learning recommendation computing entity 106 can be configured to provide one or more predictions using one or more artificial intelligence techniques and/or one or more machine learning techniques. For instance, the machine learning recommendation computing entity 106 can be configured to determine forecasts, insights, predictions, and/or classifications related to data from disparate database systems. The machine learning recommendation computing entity 106 can be additionally or alternatively configured to compute optimal recommendations, compute optimally ranked recommendations, compute optimal decisions, display optimal data for a dashboard (e.g., a graphical user interface), generate optimal data for reports, optimize actions, and/or optimize configurations associated with a decision management system, a workflow management system, a clinical decision automation system, a medical claim adjudication system, a clinical review system, and/or another type of system.

The machine learning recommendation computing entity 106 includes a rules engine 110, a machine learning engine 112, and/or an action engine 114. In some embodiments, the rules engine 110 can generate a set of recommendation data objects for a user identifier associated with a user interface based on a set of predefined rules associated with input data provided via a user interface workflow associated with the user interface. In some embodiments, the machine learning engine 112 can determine one or more predictions and/or classifications based on recommendation data 121 and/or source data 122. The recommendation data can be associated with the set of recommendation data objects. The source data 122 can be associated with user behavior data associated with the user identifier, a domain features set associated with respective domain classifications for the set of recommendation data objects, and/or a demographics features set associated with the input data. In some embodiments, the machine learning engine 112 can generate a ranked version of the set of recommendation data objects. The machine learning engine 112 can generate the ranked version of the set of recommendation data objects based on the input data and/or the source data 122 (e.g., user behavior data associated with the user identifier, a domain features set associated with respective domain classifications for the set of recommendation data objects, and/or a demographics features set associated with the input data).

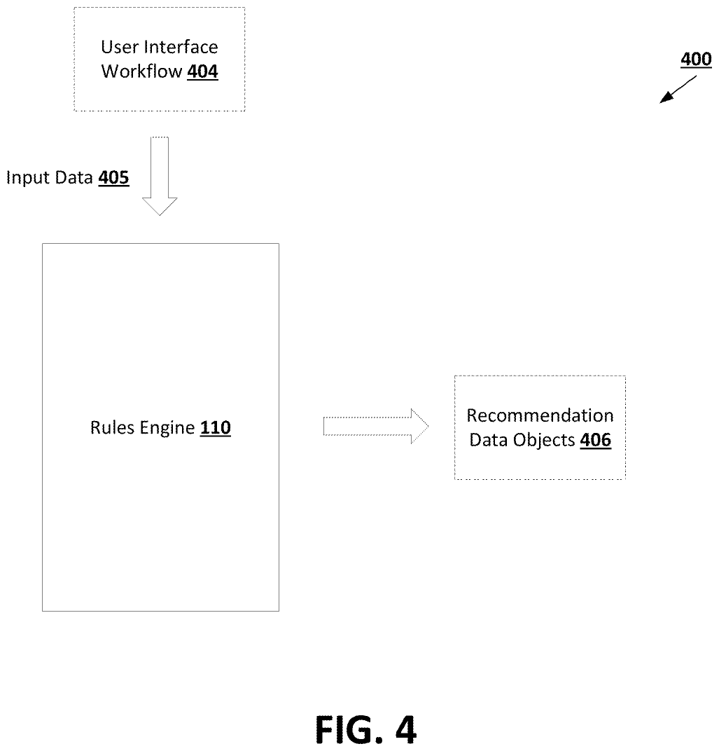

The action engine 114 can employ the one or more predictions and/or classifications associated with the machine learning engine 112 to perform one or more actions. In certain embodiments, the action engine 114 can employ the one or more predictions and/or classifications associated with the machine learning engine 112 to provide one or more visualizations via a user interface of a display (e.g., display 316). In certain embodiments, the action engine 114 can initiate a rendering of a set of selectable graphical elements based on the ranked version of the set of recommendation data objects. The rendering of the set of selectable graphical elements can be presented via the user interface. In certain embodiments, the action engine 114 can employ the one or more predictions and/or classifications associated with the machine learning engine 112 to optimize one or more machine learning models employed by the machine learning engine 112. As such, the machine learning recommendation computing entity 106 can provide accurate, efficient and/or reliable predictions and/or classifications using machine learning. Further example operations of the rules engine 110, the machine learning engine 112, and/or the action engine 114 are described with reference to at least FIGS. 4-9.

In one or more embodiments, the recommendation data 121 and/or the source data 122 can be stored in the storage subsystem 108. The storage subsystem 108 can include one or more storage units, such as multiple distributed storage units that are connected through a computer network. In certain embodiments, the recommendation data 121 and/or the source data 122 can be stored in disparate storage units (e.g., disparate databases) of the storage subsystem 108. Each storage unit in the storage subsystem 108 can store at least one of one or more data assets and/or one or more data about the computed properties of one or more data assets. Moreover, each storage unit in the storage subsystem 108 can include one or more non-volatile storage or memory media including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

Various embodiments provide technical solutions to technical problems corresponding to predictive data analysis. In particular, predictive data analysis techniques related to sparce data and/or user interface workflows tend to be difficult, resource intensive, and/or inaccurate. For example, providing rules-based recommendations for user interface workflows based on sparce data associated with the user interface workflows generally results in inaccurate, inefficient, and/or unreliable recommendations for user interface workflows. Additionally, providing rules-based recommendations for user interface workflows based on sparce data associated with the user interface workflows generally results in the rules-based recommendations being rendered via the user interface in an inconsumable manner. Additionally, extensive querying and/or interactions with respect to a user interface as a result of the rules-based recommendations generally involves inefficient usage of computational resources for a user device that includes the user interface. However, with the architecture 100 and one or more other embodiments disclosed herein, one or more technical improvements can be provided such as improved accuracy and a reduction in computationally intensiveness and time intensiveness needed for automated managing, ingesting, monitoring, updating, and/or extracting/retrieving of data for providing recommendation predictions using machine learning. With the architecture 100 and one or more other embodiments disclosed herein, reduction in computational resources required for automated managing, ingesting, monitoring, updating, and/or extracting/retrieving of data for providing recommendation predictions using machine learning can also be provided. The architecture 100 can also allocate processing resources, memory resources, and/or other computational resources to other tasks while executing one or more processes related to providing recommendation predictions using machine learning in parallel. As such, various embodiments of the present disclosure therefore provide improvements to the technical field of predictive data analysis. In certain embodiments, a user interface of a computing device that renders at least a portion of recommendations, predictions, classifications, and/or insights can also be improved by optimally presenting visual data related to the recommendations, predictions, classifications, and/or insights.

### III. Examples of Certain Terms

In some embodiments, the term “recommendation data object” refers to a data entity that describes a recommendation that matches a goal of a user identifier associated with a user interface workflow to a domain identifier. A recommendation data object, for example, may be indicative (e.g., include a domain identifier, textual description, graphical elements, etc.) of a domain entity that is associated with one or more source features from a domain knowledge datastore. By way of example, a recommendation data object may include a domain knowledge profile for a domain identifier that includes a plurality of source features corresponding to the domain identifier. The domain identifier may depend on the user interface workflow. As one example, in a healthcare domain, a domain entity may be a healthcare plan (e.g., a health insurance plan, a Medicare plan, etc.). In some embodiments, a recommendation data object may correspond to a particular plan recommendation (e.g., healthcare plan recommendation, health insurance plan recommendation, Medicare plan recommendation, etc.).

In some embodiments, the term “domain knowledge profile” refers to a data entity that describes a particular domain and/or entity. The domain knowledge profile may include a plurality of features corresponding to the particular domain and/or entity. In some examples, the domain knowledge profile may include a plan profile identifying a plurality of source features corresponding to the healthcare plan. In some examples, the plurality of source features may be distributed across a plurality of different information channels. Each of the source features may include one or more searchable attributes, such as source text attributes that may be searched using keyword matching techniques, source embedding attributes that may be searched using embedding matching techniques, and/or the like.

In some embodiments, the term “domain knowledge datastore” refers to a dataset for a domain. For example, a domain knowledge datastore may include a comprehensive dataset that aggregates data from a plurality of disparate data sources associated with a domain. In some examples, the aggregated data may be stored in one or more different verticals to enable targeted retrieval and ingestion operations for accessing data. For example, the domain knowledge datastore may include source data that is associated with a plurality of different sub-domains within a domain. In some examples, the source data may be ingested through one or more different channels tailored to each of the sub-domains. In some embodiments, the search domain is associated with a plurality of potential recommendation results. The potential recommendation results may be represented within the domain knowledge datastore as recommendation data object. The recommendation data object may include a plurality of source features that describe one or more characteristics of the recommendation data object.

In some embodiments, the domain knowledge datastore includes different sets of data for different domains. For example, in a healthcare domain, a domain knowledge datastore may include a plurality of recommendation data objects that correspond to one or more healthcare profiles for one or more healthcare plans within one or more different healthcare networks. For example, the domain knowledge datastore may augment plan profiles with healthcare knowledge, machine learning techniques, and/or the like, such that each source feature of a healthcare plan profile is searchable using natural language. In some embodiments, the domain knowledge datastore includes one or more models, such as the language model, a machine learning embedding model, and/or the like. The machine learning embedding model, for example, may be leveraged to generate a plurality of source embedding attributes to augment the features of the domain knowledge datastore. In some examples, the models may be accessible (e.g., through machine learning service application programming interfaces (APIs), etc.) to process a query for a recommendation data object. In some examples, the domain knowledge datastore may include, for a healthcare domain, a plurality of plan profiles, including plan names, plan types, plan codes, plan coverage information, plan services information, plan costs, monthly premiums, copay information, out-of-pocket maximums, healthcare provider information, prescription drug information, estimate annual prescription drug costs, dental coverage information, network IDs, discount information, summary of benefits, ratings, and/or other miscellaneous information related to a plan.

In some embodiments, the term “user interface workflow” refers to an interactive visualization rendered via a user interface of a user device. For example, a user can interact with a user interface (e.g., a website portal) via a user device to initiate a user interface workflow. In some embodiments, the user interface workflow is a real-time website session associated with a user interface. The user interface workflow can include a series of interactive graphical elements based on user interactions via the user interface. In some embodiments, the user interface workflow is configured as a decision support system for providing personalized recommendations (e.g., personalized plan recommendations) to a user via the user interface. In some examples, the user interface workflow is a questionnaire provided via the user interface. In some embodiments, the user interface workflow may receive user responses to questions for the questionnaire. In some examples, the user responses can include one or more features such as zip-code, county, and/or a type of user preference related to the user. In some embodiments, after completion of the responses to all the questions, the questions and responses can be processed to generate a set of recommendations. In some embodiments, the user interface workflow can capture preferences for a user identifier via a dynamically changing questionnaire. Data provided via the questionnaire can be merged with domain features to generate recommendation options for a user identifier. For example, depending on a user preference for a type of plan coverage, the questions displayed via the user interface workflow can vary. In some embodiments, the user interface workflow can include a point-based system that assigns points to recommendations based on user responses to the questionnaire and the logic of points allocation can be derived from a goal and understanding of user requirements.

In some embodiments, the user interface workflow includes a plurality of workflows. For example, a user interface workflow can include multiple separate workflows that is determined based on user selection of questions from options such as, for example, ‘I'd like to see all Medicare Plans’, ‘Medicare Advantage (Part C) Plans’, ‘Medicare Supplement Insurance (Medigap) Plans’ and ‘Medicare Prescription Drug (Part D) Plans’. As such, if a user selects the option ‘I'd like to see all Medicare Plans’, the user can be presented with the following questions: Special Needs, Doctors, Prescription Drugs, Additional Services, Cost Preferences and Priorities via the user interface workflow. In another example, if a user selects the option ‘Medicare Advantage (Part C)’, the user can be presented with the following questions: Current coverage, Special considerations, Doctors, Prescription drugs and Ranking plan recommendations via the user interface workflow. In yet another example, if a user selects the option ‘Medicare Supplement Insurance (Medigap) Plans’, the user can be presented with the following questions: Cost preferences, Medicare eligibility, Plan preferences and Prescription drugs via the user interface workflow. In yet another example, if a user selects the ‘Medicare Prescription Drug (Part D) Plans’ option, the user can be presented with the following questions: Prescription Drugs and optionally the drug list page via the user interface workflow. As such, depending on the workflow chosen by the user, a series of questions for the user can be presented via the user interface workflow. In some embodiments, questions can include special needs questions, preferences for a type of coverage, provider questions, prescription drug questions, service questions, discount questions, cost preference questions, user priority questions, user location (e.g., zip-code, county, etc.) questions, etc.

In some embodiments, the term “predefined rule” refers to a data entity that describes a rule that is predefined for a user interface workflow based on user responses (e.g., real-time web session activity) during the user interface workflow. In some embodiments, a predefined rule can be based on points accumulated in response to user answers to questions during a user interface workflow. In some embodiments, a predefined rule utilizes a points table to determine a score for a particular recommendation. In some embodiments, a predefined rule is managed by a rules-based engine.

In some embodiments, the term “input data” refers to a data entity that describes real-time session activity for a user during a user interface workflow. For example, the input data can include information provided by a user during a user interface workflow. In some embodiments, the input data includes user information provided during the user interface workflow such as, but not limited to, user location information (e.g., zip-code, county, etc.), user preferences (e.g., a type of plan coverage preference), etc. In some embodiments, the input data includes answers to questions during the user interface workflow such as answers to special needs questions, preferences for a type of coverage, provider questions, prescription drug questions, service questions, discount questions, cost preference questions, user priority questions, etc.

In some embodiments, the term “user behavior data” refers to a data entity that describes behavior of a user identifier associated with a user interface workflow. In some embodiments, the user behavior data can describe behavior of the user identifier based on one or more user interface workflows that are different than a current user interface workflow being presented via a user interface. In some embodiments, the user behavior data includes website activity data, postback data, event data, electronic communication data, session identifiers, metadata, and/or other data related to user behavior. In some embodiments, the user behavior data can be received from a third-party data source. In some embodiments, the user behavior data can include a set of binary encodings for particular attributes related to a current user interface workflow and/or one or more different user interface workflows associated with the user identifier. In some embodiments, the set of binary encodings can include includes features that indicate presence or absence of particular attributes related to various questionnaire responses during a current user interface workflow and/or one or more different user interface workflows associated with the user identifier. In some embodiments, the user behavior data includes questions and responses, time information as to when a user interface workflow is started, location information related to the user identifier, etc. In some embodiments, the user behavior data includes a one-hot encoding for various questionnaire responses. A one-hot encoding can be related to coverage flow, plan eligibility, services preference, priority preference, cost preference, doctors, prescription drugs, ranking plan recommendations, plan preferences, Medicare eligibility, closeness to an Annual Enrollment Period (AEP) based on the time information as to when a user interface workflow is started, and/or other information.

In some embodiments, the term “domain features set” refers to a collection of data constructs that describes features and/or attributes for a domain. In some embodiments, a domain features set corresponds to features and/or attributes for a healthcare plan. In some embodiments, one or more portions of a domain features set can be obtained from a domain knowledge profile and/or a domain knowledge datastore. In an example, a domain features set can include features such as, but not limited to, features related to member costs for a healthcare plan, a plan type indicator, plan costs, doctor visits, provider information, plan ratings, features related to medical benefits, features related to prescription drugs, features related to additional benefits, features related to dental coverage, and/or other domain features. In some embodiments, features related to medical benefits can include, but is not limited to, outpatient services, inpatient services, hospital services, mental health services, treatment program services, home health services, annual wellness visits, skilled nursing facilities, ground ambulance services, emergency services, annual routine physical exams, diabetic monitoring supplies, procedures information, x-ray information, lab services, diagnostic procedures/tests, diabetes screening, diagnostic radiological services, air ambulance services, ambulatory surgical services, urgent care, hearing exams, hearing aids, eyewear, eye exams, fitness, meal benefits, medical telehealth, footcare, chiropractors, acupuncture, and/or medical benefits information. In some embodiments, features related to prescription drugs can include, but is not limited to, premiums, deductibles, initial coverage limits, thresholds, pay associated with prescription tiers, and/or other prescription drug information.

In some embodiments, the term “demographics features set” refers to a collection of data constructs that describes features and/or attributes for a domain classification for one or more recommendation data objects. For example, features and/or attributes for a demographics features set can be related to socio-demographic information for a domain classification for one or more recommendation data objects. In some embodiments, a domain classification can correspond to a particular medical plan, a particular type of medical plan, and/or a particular geographic location. In some embodiments, a demographics features set can include features and/or attributes at a particular geographic location (e.g., zip-code level) based on demographic indicators, socioeconomic indicators, risk flags (e.g., geographic level of scoring using historical credit and/or payment behavior), estimated household debt, net worth indicators, dual income information, short term loan indexes, and/or other socio-demographic information at a particular geographic location. In some embodiments, a demographics features set can include features and/or attributes that are aggregated at a plan/zip code/county level, popular plan flags for medical plan offerings at zip code/county level, a nearest/closest medical plan offerings for zip code/county level, etc. In some embodiments, a demographics features set can include features and/or attributes related to historical data for different healthcare plans. For example, a demographics features set can include information related to similarity (e.g., cosine similarity) between healthcare plans such that relevance-based popularity of a plan at a particular location is mapped.

In some embodiments, the term “prediction output” refers to a data construct that describes one or more prediction recommendations, insights, classifications, and/or inferences provided by one or more machine learning models. In various embodiments, prediction recommendations, insights, classifications, and/or inferences may be with respect to a ranking of recommendation data objects. In certain embodiments, a prediction output can provide a prediction as to whether a particular recommendation data object for a user identifier is likely to be beneficial for the user identifier.

In some embodiments, the “machine learning framework” refers to a data construct that describes parameters, hyperparameters, and/or defined operations of one or more machine learning models configured to generate a prediction output. In some embodiments, the machine learning framework process input data, user behavior data, a domain features set, a demographics features set, and/or other data to provide a ranked version of a set of recommendation data objects.

In some embodiments, the term “machine learning model” refers to a data construct that describes parameters, hyperparameters, and/or defined operations configured to generate a prediction output using machine learning techniques. In some embodiments, a machine learning model is configured and/or trained to generate a ranked version of a set of recommendation data objects where a highest ranked recommendation data object corresponds to a most likely beneficial recommendation for a user identifier associated with a user interface workflow. In certain embodiments, a machine learning model is trained based on ground-truth outputs (e.g., ground-truth code classifications and/or the like) for a set of training data. In certain embodiments, a machine learning model may be configured as a neural network model, a deep learning model, a convolutional neural network (CNN) model, and/or another type of machine learning model configured for recommendations, predictions, classifications, and/or inferences related to a domain.

In some embodiments, a machine learning model is a learning-to-rank (LTR) machine learning model that ranks or re-ranks a set of recommendation data objects to improve relevancy and/or personalization of the recommendation data objects for a user identifier. In some embodiments, the LTR machine learning model can model input data, user behavior data, a domain features set, and/or a demographics data set such that more relevant recommendations for a user identifier is located at a beginning of recommendation list. In some embodiments, the LTR machine learning model can determine a respective relevance score for respective recommendation data objects to determine the ranking. In some embodiments, the LTR machine learning model can utilize extreme gradient boosting, categorical boosting, and/or one or more other techniques to further optimize the ranking.

In some embodiments, the term “user identifier” refers to a data entity that identifies a user associated with a user interface workflow. In some examples, a user identifier may be determined using information associated with a user device. For example, user device information, network address information, and/or other information included in a header portion, a data segment portion, metadata, or another portion of a workflow may be correlated to a user identifier.

In some embodiments, the term “selectable graphical element” refers to a formatted version of one or more recommendation data objects to provide a visualization and/or human interpretation of data associated with the one or more recommendation data objects via a user interface. In some embodiments, a selectable graphical element may additionally or alternatively be formatted for transmission via a network, an API, a communication channel, a communication interface, the like, or combinations thereof. In one or more embodiments, a selectable graphical element may include one or more graphical elements and/or one or more textual elements that may be selectable and/or otherwise interacted with via a user interface.

In some embodiments, the term “user location data” refers to a location information (e.g., a GPS position, a latitude/longitude, an address, a geofence location, etc.) associated with a user device and/or a user identifier. In some examples, the user location data may be based on a location module of the user device. The location module may be adapted to acquire, for example, latitude, longitude, altitude, geocode, course, direction, heading, speed, UTC, date, and/or various other information/data. In one embodiment, the location module may acquire data, such as ephemeris data, by identifying the number of satellites in view and the relative positions of those satellites (e.g., using GPS). The satellites may be a variety of different satellites, including LEO satellite systems, DOD satellite systems, the European Union Galileo positioning systems, the Chinese Compass navigation systems, Indian Regional Navigational satellite systems, and/or the like. This data may be collected using a variety of coordinate systems, such as the DD; DMS; UTM; UPS coordinate systems; and/or the like. Alternatively, the location information/data may be determined by triangulating a position of the user device in connection with a variety of other systems, including cellular towers, Wi-Fi access points, and/or the like. In some embodiments, the location module may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, BLE transmitters, NFC transmitters, and/or the like.

In some examples, the user location data may be additionally or alternatively based on location text input provided via the user interface. For example, the location text input may be a sequence of text such as text input and/or text generated from one or more audio, tactile, and/or like inputs. In some examples, the location text input may correspond to an address associated with the user device.

### IV. Overview

The present disclosure addresses technical challenges related to rules-based recommendation engines for user interfaces. Existing rules-based recommendation engines are ill-suited to accurately, efficiently, and/or reliably provide recommendations for user interface workflows in a consumable manner. This results in wasted computing resources for user interface workflows where certain recommendation results are generated but presented via a user interface behind other less relevant recommendation results. For example, traditional user interfaces provide static recommendation results in a list form based on rules-based logic for input provided via a user interface workflow. However, the list of recommendation results lack personalized information for a user, resulting in vast expenditures of time and computing resources as the user interacts with multiple irrelevant recommendation results via the user interface before identifying a sufficient recommendation result. In an example, a traditional recommendation engine that utilize rules-based logic can present the same set of recommendations to two different individuals for a same response sequence. As such, a traditional rules-based recommendation engine typically does not account for personalization or user behavior patterns while presenting the recommendations. A traditional rules-based recommendation engine is also not typically equipped to adapt and adjust dynamically by learning from the behavior and/or interactions of individuals with respect to user interface workflows.

Discussed herein are methods, apparatus, systems, computing devices, computing entities, and/or the like for analysis of digital data using machine learning. Certain embodiments utilize methods, apparatus, systems, computing devices, computing entities, and/or the like for additionally performing actions based on the analysis of the digital data and/or predictions associated therewith. In various embodiments, methods, apparatus, systems, computing devices, computing entities, and/or the like that provide machine learning and rules-based recommendations for user interface workflows. For example, to improve upon a traditional recommendation engine that utilizes rules-based logic, a combination of machine learning and rules-based logic can be utilized to provide personalized recommendations to individuals. In some embodiments, a rules-based recommendation engine can provide domain-specific features for a user interface workflow and a machine learning engine (e.g., one or more machine learning layers of a machine learning model) can provide personalization features to improve an initial set of recommendations provided by the rules-based recommendation engine.

In some embodiments, an initial set of recommendations may be generated by a rules-based recommendation engine based on predefined rules. For example, a user can interact with a user interface (e.g., a website portal) via a user device to initiate a user interface workflow. The initial set of recommendations can be based on input data provided during the user interface workflow. In some examples, the user interface workflow is a questionnaire provided via the user interface. In some embodiments, the input data may be related to user responses to questions for the questionnaire. In some examples, the input data can include one or more features such as zip-code, county, and/or a type of user preference related to the user. After completion of the responses to all the questions, the questions and responses can be processed via a rules-based engine application programming interface (API) and/or a related rules-based recommendation engine to generate the initial set of recommendations.

In some embodiments, additional data related to the user and/or a domain associated with the recommendations can be collected and/or processed. In some embodiments, the additional data related to the user and/or the domain can be provided to one or more machine learning models via a machine learning API implemented between the rules-based engine and the machine learning models. The additional data can include user behavior data associated with the user identifier, a domain features set associated with respective domain classifications for the initial set of recommendations, and/or a demographics features set associated with the input data.

In some examples, the additional data can include user web-activity data captured from a website page, domain features corresponding to each of rules-based recommendations, socio-demographic information aggregated for a particular location (e.g., domain location/zip code/county level, etc.), popular domain flags for domain offerings at the particular location, a nearest/closest domain offerings for the particular location, etc. In some embodiments, the user behavior data can include postback data captured from previous user interface workflows and/or previous electronic communications associated with the user. In some embodiments, the user behavior data can be processed and/or feature engineered to facilitate input of the user behavior data into machine learning models. In some embodiments, the user behavior data includes features related to binary encodings to indicate presence or absence of particular attributes related to various responses (e.g., questionnaire responses) and/or interactions during the user interface workflow.

In some embodiments, the machine learning model can be utilized to re-rank the initial set of recommendations based on the additional data. In some embodiments, the machine learning model can be a learning-to-rank (L2R) model. However, as will be recognized, the disclosed concepts can be used to perform any type of machine learning for re-ranking the initial set of recommendations. Examples of machine learning include, but are not limited to, linear regression modeling, supervised machine learning (e.g., classification analysis, regression analysis, etc.), unsupervised machine learning (e.g., clustering analysis, etc.), semi-supervised machine learning, deep learning, neural network architectures, and/or the like. In some embodiments, the machine learning model may re-rank the initial set of recommendations based on recommendation weightage. Additionally, the re-ranked recommendations can be transmitted to a rules-based API associated with the rules-based recommendation engine to present the re-ranked recommendations via the user interface.

In doing so, various embodiments of the present disclosure address shortcomings of existing traditional recommendation techniques and/or user experiences related therewith by providing solutions that are capable of efficient and reliable processing of user interface workflows while also providing efficient and reliable recommendations visualizations related to recommendation results via machine learning. For example, using some of the techniques of the present disclosure, user interface workflows initiated via a user interface may be resolved in a shorter amount of time and/or by utilizing fewer computing resources as compared to traditional user interface workflow techniques. Additionally, or alternatively, visualizations related to recommendations for the user interface workflows may be rendered in a shorter amount of time and/or by utilizing fewer computing resources as compared to traditional user experiences for traditional user interfaces. Example inventive and technologically advantageous embodiments of the present disclosure additionally include improved data analytics, data processing, and/or machine learning with respect to data related to user interface workflows. Example inventive and technologically advantageous embodiments of the present disclosure additionally include improved quality and/or accuracy of recommendation results related to user interface workflows.

The machine learning disclosed can also provide significant advantages over existing technological solutions, such as, improved integrability, reduced complexity, improved accuracy, and/or improved speed as compared to existing technological solutions for providing insights and/or forecasts related to data. Accordingly, by employing various techniques related to the hybrid machine learning and rules-based framework disclosed herein, various embodiments of the present disclosure enable utilizing efficient and reliable machine learning solutions to process data feature spaces with a high degree of size, diversity and/or cardinality. In doing so, various embodiments of the present disclosure address shortcomings of existing system solutions and enable solutions that are capable of accurately, efficiently and/or reliably providing recommendations, forecasts, insights, and classifications to facilitate optimal decisions and/or actions related to the user interface workflows. Moreover, by employing various techniques related to the hybrid machine learning and rules-based framework disclosed herein, one or more other technical benefits can be provided, including improved interoperability, improved reasoning, reduced errors, improved information/data mining, improved analytics, and/or the like related to machine learning. Accordingly, the hybrid machine learning and rules-based framework disclosed herein provides improved predictive accuracy for recommendations without reducing training speed and also enable improving training speed given a constant predictive accuracy. In doing so, the techniques described herein can additionally or alternatively improve efficiency and speed of training machine learning models, thus reducing the number of computational operations needed and/or the amount of training data entries needed to train machine learning models. Accordingly, the techniques described herein improve at least one of the computational efficiency, storage-wise efficiency, and speed of training machine learning models.

Moreover, examples of technologically advantageous embodiments of the present disclosure include: (i) a hybrid recommendation engine that utilizes a combination of machine learning and rules-based logic, (ii) a machine learning API that leverages data from a rules engine API to deliver optimized recommendations to a user interface efficiently, and/or (iii) a real-time user interface visualization optimized for presenting recommendation results, among other aspects of the present disclosure. Other technical improvements and advantages may be realized by one of ordinary skill in the art.

### V. Example System Operations

To provide the significant advantages over existing technological solutions related to rules-based recommendation engines for user interfaces, such as, improved integrability, reduced complexity, improved accuracy, and/or improved speed as compared to existing technological solutions for providing recommendations related to user interface workflows. Accordingly, by employing various techniques related to the hybrid machine learning and rules-based framework disclosed herein, various embodiments of the present disclosure enable utilizing efficient and reliable machine learning solutions to process data feature spaces with a high degree of size, diversity and/or cardinality. In doing so, various embodiments of the present disclosure address shortcomings of existing system solutions and enable solutions that are capable of accurately, efficiently and/or reliably providing optimized recommendations to facilitate optimal decisions and/or actions related to user interface workflows. Moreover, by employing various techniques related to the hybrid machine learning and rules-based framework disclosed herein, one or more other technical benefits can be provided, including improved interoperability, improved reasoning, reduced errors, improved information/data mining, improved analytics, and/or the like related to machine learning. Accordingly, the hybrid machine learning and rules-based framework disclosed herein provides improved predictive accuracy without reducing training speed and also enable improving training speed given a constant predictive accuracy. In doing so, the techniques described herein can additionally or alternatively improve efficiency and speed of training machine learning models, thus reducing the number of computational operations needed and/or the amount of training data entries needed to train machine learning models. Accordingly, the techniques described herein improve at least one of the computational efficiency, storage-wise efficiency, and speed of training machine learning models.

### Example Classification Prediction Machine Learning Computing Entity

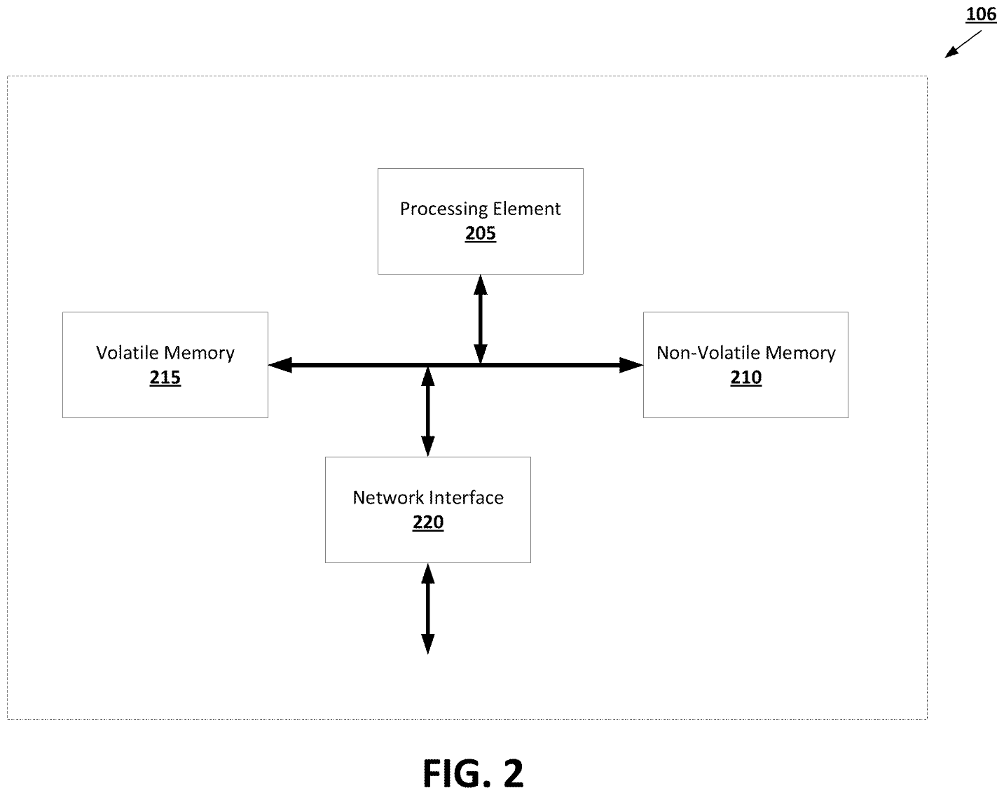

FIG. 2 provides a schematic of the machine learning recommendation computing entity 106 according to one embodiment of the present disclosure. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes may be performed on data, content, information, and/or similar terms used herein interchangeably.

As indicated, in one embodiment, the machine learning recommendation computing entity 106 may also include a network interface 220 for communicating with various computing entities, such as by communicating data, content, information, and/or similar terms used herein interchangeably that may be transmitted, received, operated on, processed, displayed, stored, and/or the like. Furthermore, it is to be appreciated that the network interface 220 may include one or more network interfaces.

As shown in FIG. 2, in one embodiment, the machine learning recommendation computing entity 106 may include or be in communication with processing element 205 (also referred to as processors, processing circuitry, and/or similar terms used herein interchangeably) that communicate with other elements within the machine learning recommendation computing entity 106 via a bus, for example. It is to be appreciated that the processing element 205 may include one or more processing elements. As will be understood, the processing element 205 may be embodied in a number of different ways. For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In one embodiment, the machine learning recommendation computing entity 106 may further include or be in communication with non-volatile memory 210. The non-volatile memory 210 may be non-volatile media (also referred to as non-volatile storage, memory, memory storage, memory circuitry, and/or similar terms used herein interchangeably). Furthermore, in an embodiment, non-volatile memory 210 may include one or more non-volatile storage or memory media, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the machine learning recommendation computing entity 106 may further include or be in communication with volatile memory 215. The volatile memory 215 may be volatile media (also referred to as volatile storage, memory, memory storage, memory circuitry, and/or similar terms used herein interchangeably). Furthermore, in an embodiment, the volatile memory 215 may include one or more volatile storage or memory media, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the machine learning recommendation computing entity 106 with the assistance of the processing element 205 and operating system.

As indicated, in one embodiment, the machine learning recommendation computing entity 106 may also include the network interface 220. In an embodiment, the network interface 220 may be one or more communications interfaces for communicating with various computing entities, such as by communicating data, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the machine learning recommendation computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the machine learning recommendation computing entity 106 may include or be in communication with one or more input elements, such as a keyboard input, a mouse input, a touch screen/display input, motion input, movement input, audio input, pointing device input, joystick input, keypad input, and/or the like. The machine learning recommendation computing entity 106 may also include or be in communication with one or more output elements (not shown), such as audio output, video output, screen/display output, motion output, movement output, and/or the like.

### Example External Computing Entity

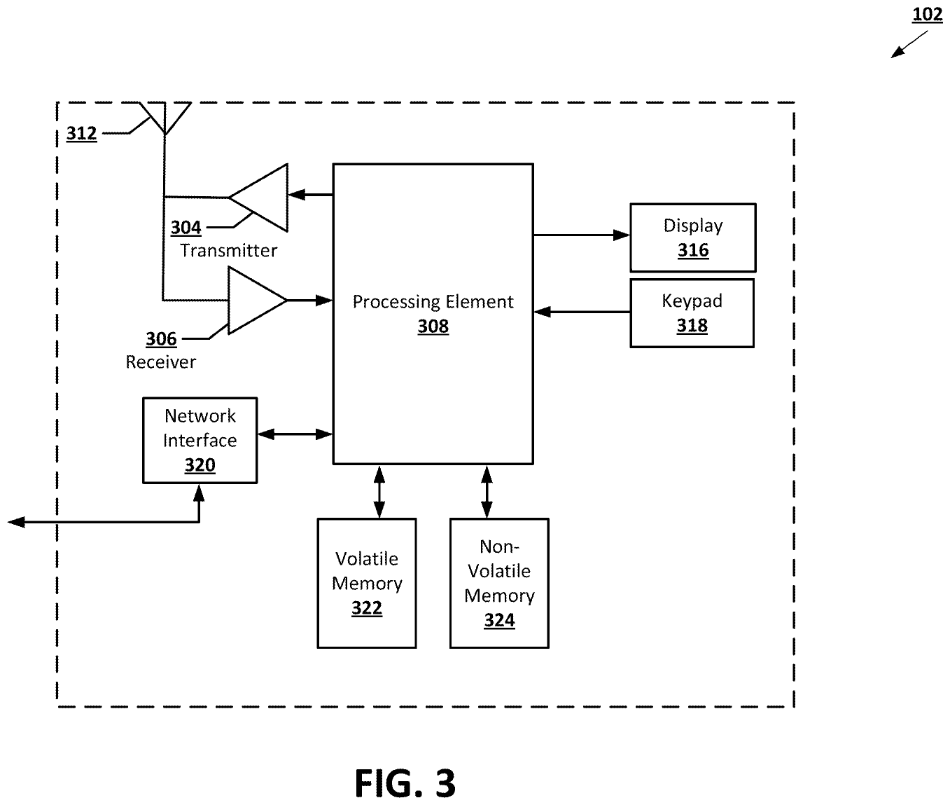

FIG. 3 provides an illustrative schematic representative of an external computing entity 102 that may be used in conjunction with embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. The external computing entity 102 may be operated by various parties. As shown in FIG. 3, the external computing entity 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) which provide signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the external computing entity 102 may be capable of operating with one or more air interface standards, communication protocols, modulation types, and access types. More particularly, the external computing entity 102 may operate in accordance with any of a number of wireless communication standards and protocols, such as those described above with regard to the machine learning recommendation computing entity 106. In a particular embodiment, the external computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the external computing entity 102 may operate in accordance with multiple wired communication standards and protocols, such as those described above with regard to the machine learning recommendation computing entity 106 via a network interface 320.

Via these communication standards and protocols, the external computing entity 102 may communicate with various other entities using concepts, such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 102 may also download changes, add-ons, and updates, for instance, to its firmware, software (e.g., including executable instructions, applications, program modules), and operating system.

According to one embodiment, the external computing entity 102 may include location determining aspects, devices, modules, functionalities, and/or similar words used herein interchangeably. For example, the external computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the external computing entity's 102 position in connection with a variety of other systems, including cellular towers, Wi-Fi access points, and/or the like. Similarly, the external computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The external computing entity 102 may also comprise a user interface (that may include a display 316 coupled to the processing element 308) and/or a user input interface (coupled to the processing element 308). For example, the user interface may be a user application, browser, user interface, graphical user interface, dashboard, and/or similar words used herein interchangeably executing on and/or accessible via the external computing entity 102 to interact with and/or cause display of information/data from the machine learning recommendation computing entity 106, as described herein. The user input interface may comprise any of a number of devices or interfaces allowing the external computing entity 102 to receive data, such as a keypad 318 (hard or soft), a touch display, voice/speech or motion interfaces, or other input device. In embodiments including a keypad 318, the keypad 318 may include (or cause display of) the conventional numeric (0-9) and related keys (#, *) and other keys used for operating the external computing entity 102, and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The external computing entity 102 may also include volatile memory 322 and/or non-volatile memory 324, which may be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile memory 322 and/or the non-volatile memory 324 may store databases, database instances, database management systems, data, applications, programs, program modules, scripts, source code, object code, byte code, compiled code, interpreted code, machine code, executable instructions, and/or the like to implement the functions of the external computing entity 102. As indicated, this may include a user application that is resident on the entity or accessible through a browser or other user interface for communicating with the machine learning recommendation computing entity 106 and/or various other computing entities.

In another embodiment, the external computing entity 102 may include one or more components or functionalities that are the same or similar to those of the machine learning recommendation computing entity 106, as described in greater detail above. As will be recognized, these architectures and descriptions are provided for example purposes only and are not limiting to the various embodiments.

In various embodiments, the external computing entity 102 may be embodied as an artificial intelligence (AI) computing entity, such as a virtual assistant AI device, and/or the like. Accordingly, the external computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

As described below, various embodiments of the present disclosure introduce techniques that improve upon rules-based recommendation engines for user interfaces by introducing a hybrid machine learning and rules-based framework that utilizes machine learning to generate a ranked version of a set of recommendation provided by a rules-based recommendation engine. In general, embodiments of the present disclosure provide methods, apparatus, systems, computing devices, computing entities, and/or the like for generating optimized recommendation output for a user interface using the hybrid machine learning and rules-based framework. The combination of the noted components enables the proposed hybrid machine learning and rules-based framework to generate more accurate recommendations for a user, which in turn reduces a number of computing resources for a user device. Certain embodiments of the systems, methods, and computer program products that facilitate recommendation prediction and/or prediction-based actions employ one or more machine learning models and/or one or more machine learning techniques. In some embodiments, one or more machine learning models to facilitate the optimized recommendations may be trained and/or generated based on the recommendation data 121 and/or the source data 122. After the one or more machine learning models are generated, the one or more machine learning models may be utilized to perform accurate, efficient, and reliable recommendation predictions and/or re-ranking of a set of recommendations.

Rules-Based Techniques for Recommendations related to a User Interface Workflow

FIG. 4 illustrates an example system 400 related to providing rules-based recommendations associated with the rules engine 110, in accordance with one or more embodiments of the present disclosure. The system 400 includes the rules engine 110. In one or more embodiments, the rules engine 110 applies rules-based logic to input data 405 related to a user interface workflow 404 to generate a set of recommendation data objects 406. For example, the rules engine 110 can generate the set of recommendation data objects 406 for a user identifier associated with the user interface workflow 404. The user interface workflow 404 can be provided via user interface of a user device. In some embodiments, the input data 405 can include real-time website session activity associated with the user interface workflow 404. In some embodiments, the rules engine 110 can generate the set of recommendation data objects 406 based on a set of predefined rules associated with the input data 405 provided via the user interface workflow 404. In some embodiments, the set of recommendation data objects 406 include domain recommendations. For example, the one or more domain recommendations may be plan recommendations (e.g., medical plan recommendations) related to a healthcare system.

### Machine Learning Techniques for Ranking Recommendations Related to a User Interface Workflow

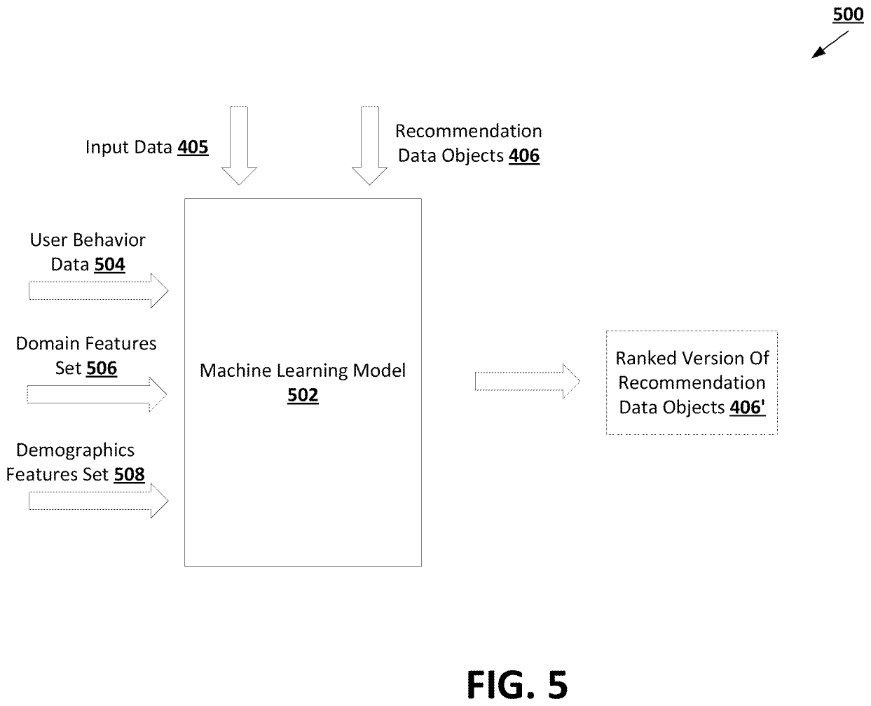

FIG. 5 illustrates an example system 500 related to providing machine learning associated with the machine learning engine 112, in accordance with one or more embodiments of the present disclosure. The system 500 includes a machine learning model 502. In one or more embodiments, the machine learning engine 112 may employ the machine learning model 402 to rank the recommendation data objects 406. For example, the machine learning model 402 can generate a ranked version of the recommendation data objects 406′. In one or more embodiments, the machine learning engine 112 generates, using the machine learning model 502, the ranked version of the set of recommendation data objects 406′ based on the input data 405, user behavior data 504, a domain features set 506, and/or a demographics features set 508. The user behavior data 504 can be associated with the user identifier related to the user interface workflow 404. The domain features set 506 can be associated with respective domain classifications for the set of recommendation data objects 406. The demographics features set 508 can be associated with the input data 405.

In some embodiments, the machine learning model 502 applies learning-to-rank (LTR) machine learning to the input data 405, the user behavior data 504, the domain features set 506, and/or the demographics features set 508. For example, in some embodiments, the machine learning model 502 can be a LTR model that utilizes supervised, semi-supervised, and/or reinforcement learning to rank the set of recommendation data objects 406 in a personalized manner for the user identifier associated with the user interface workflow 404.

In some embodiments, the user behavior data 504 can be received from a third-party data source. Additionally, the machine learning engine 112 can transform the user behavior data 504 into a user behavior features set. The machine learning engine 112 can then apply the machine learning model 502 to the user behavior features set. In some embodiments, the user behavior data 504 includes a set of binary encodings for particular attributes related to one or more different user interface workflows associated with the user identifier. As such, in some embodiments, the machine learning engine 112 can apply the machine learning model 502 to the set of binary encodings. In some embodiments, the user behavior data 504 can include website activity data associated with the user identifier and the machine learning engine 112 can apply the machine learning model 502 to the include website activity data.

In some embodiments, the action engine 114 can initiate a rendering of a set of selectable graphical elements based on the ranked version of the set of recommendation data objects 406′. For example, the action engine 114 can initiate the rendering of the set of selectable graphical elements via a user interface associated with the user interface workflow 404. In some embodiments, the action engine 114 can transmit the ranked version of the set of recommendation data objects 406′ to an API associated with the user interface to facilitate the rendering of the set of selectable graphical elements via the user interface.

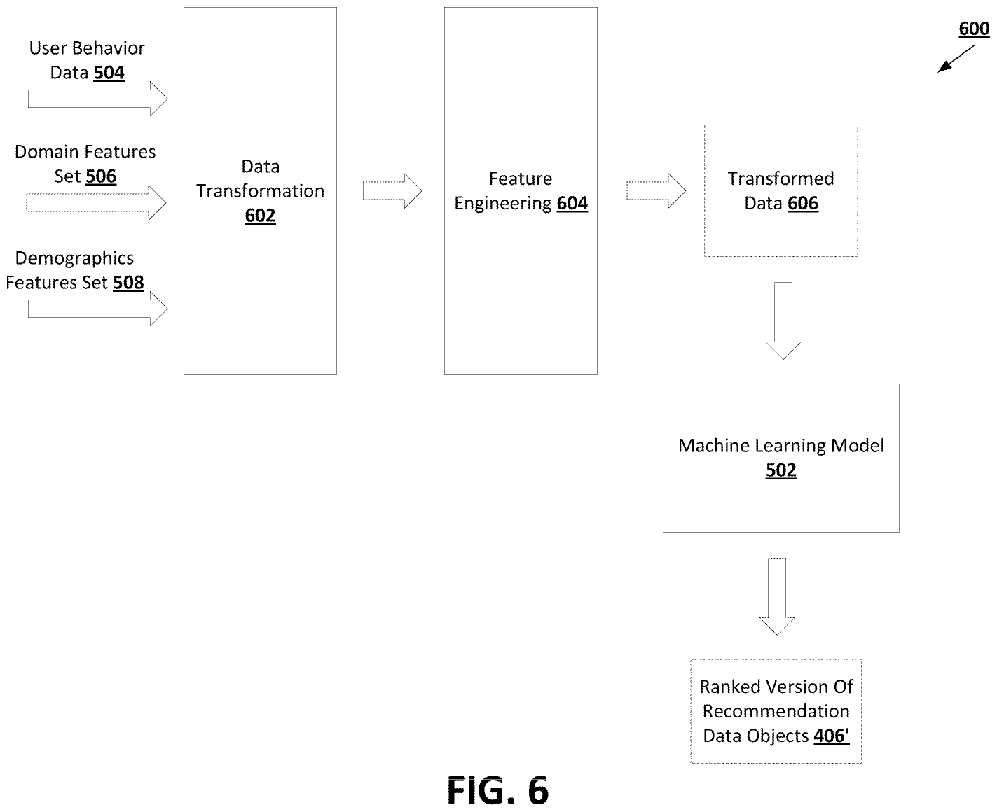

FIG. 6 illustrates an example system 600 related to providing transformed data for machine learning associated with the machine learning engine 112, in accordance with one or more embodiments of the present disclosure. The system 600 includes data transformation 602 and/or feature engineering 604 provided by the machine learning engine 112. In some embodiments, the data transformation 602 performs data transformation with respect to the user behavior data 504, the domain features set 506, and/or the demographics features set 508. The data transformation can include data standardization, data formatting, data cleaning, variable creation, data exploration, variable selection, and/or one or more other data transformations associated with the user behavior data 504, the domain features set 506, and/or the demographics features set 508. Additionally or alternatively, in some embodiments, the feature engineering 604 performs feature extraction and/or one or more other feature engineering techniques with respect to the user behavior data 504, the domain features set 506, and/or the demographics features set 508 to generate transformed data 606. The transformed data 606 can include a features set related to the user behavior data 504, the domain features set 506, and/or the demographics features set 508 that can be provided as input to the machine learning model 502. For example, the machine learning model 502 can be applied to the transformed data 606 to generate the ranked version of the set of recommendation data objects 406′.

Prediction-Based Actions and/or Visualizations

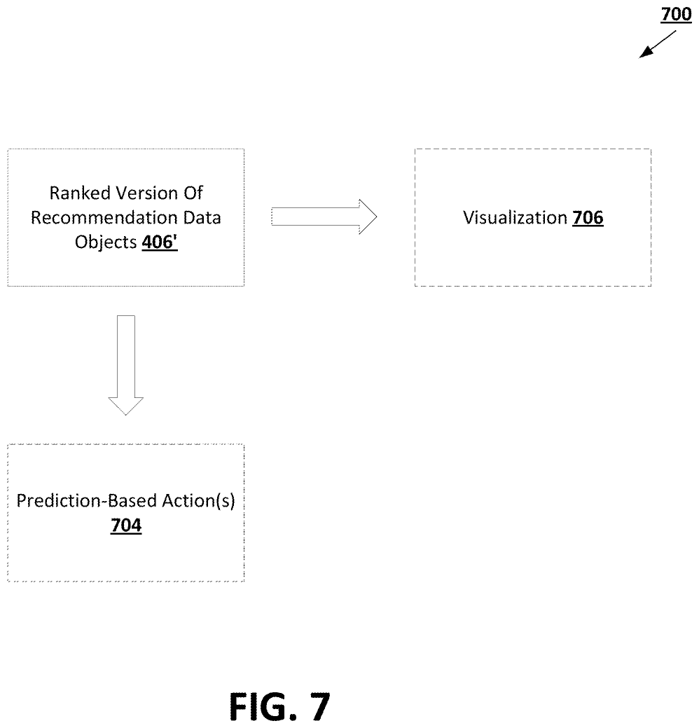

FIG. 7 illustrates an example system 700 for providing prediction-based actions and/or visualizations, in accordance with one or more embodiments of the present disclosure. The system 700 includes the ranked version of the set of recommendation data objects 406′ provided by the machine learning model 502. In one or more embodiments, one or more prediction-based actions 704 are performed based on the ranked version of the set of recommendation data objects 406′. For example, data associated with the ranked version of the set of recommendation data objects 406′ may be stored in a storage system, such as the storage subsystem 108 or another storage system associated with the machine learning recommendation system 101. The data stored in the storage system may be employed for providing recommendations, reporting, decision-making purposes, operations management, healthcare management, and/or other purposes. In certain embodiments, the data stored in the storage system may be employed to provide one or more insights to assist with healthcare decision making processes, such as, medical plan decisions during the user interface workflow 404. Additionally or alternatively, the machine learning model 502 may be retrained based on one or more features associated with the ranked version of the set of recommendation data objects 406′. For example, one or more relationships between features mapped in the machine learning model 502 may be adjusted (e.g., refitted) based on data associated with the ranked version of the set of recommendation data objects 406′. In another example, cross-validation, hyperparameter optimization, and/or regularization associated with the machine learning model 502 may be adjusted based on one or more features associated with the ranked version of the set of recommendation data objects 406′. Additionally or alternatively, a visualization 806 may be generated based on the ranked version of the set of recommendation data objects 406′. The visualization 806 may include, for example, one or more selectable graphical elements for a user interface (e.g., an electronic interface of a user device) based on the ranked version of the set of recommendation data objects 406′.

In some embodiments, the one or more prediction-based actions 704 may include automated alerts, automated instructions to user devices, and/or automated adjustments to allocations of computing resources. Further, the one or more prediction-based actions 704 may include automated physician notification actions, automated patient notification actions, automated appointment scheduling actions, automated prescription recommendation actions, automated record updating actions, automated datastore updating actions, automated workforce management operational management actions, automated server load balancing actions, automated resource allocation actions, automated pricing actions, automated plan update actions, automated alert generation actions, generating one or more electronic communications, and/or the like. The one or more prediction-based actions 704 may further include displaying visual renderings of the aforementioned examples of prediction-based actions in addition to values, charts, and representations associated with the one or more policy scores and the prediction output using a prediction output user interface such as, for example, the visualization 706.

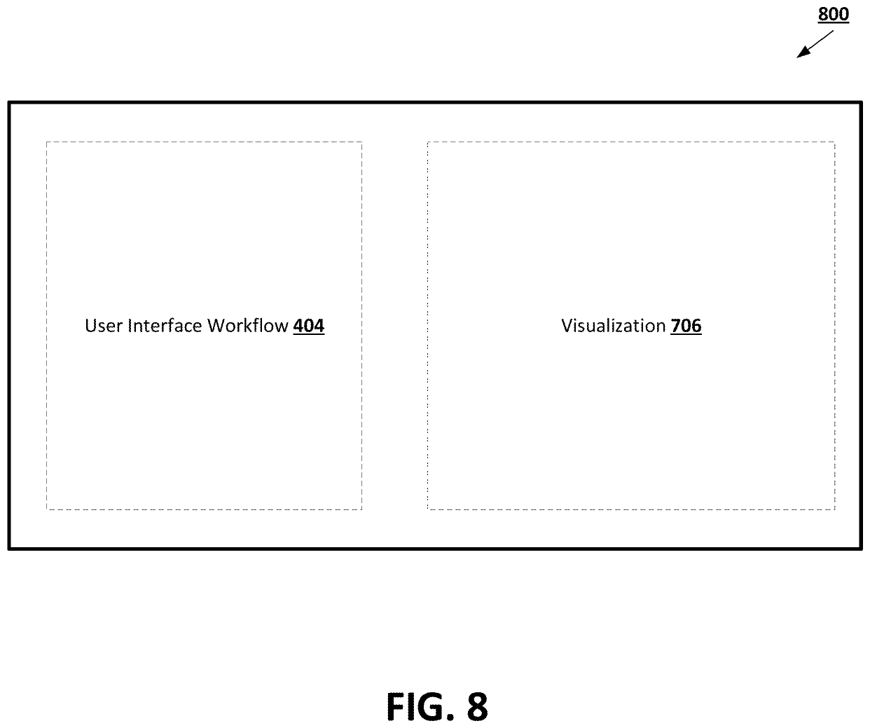

FIG. 8 illustrates an example user interface 800 for providing prediction-based visualizations, in accordance with one or more embodiments of the present disclosure. In one or more embodiments, the user interface 800 is, for example, an electronic interface (e.g., a graphical user interface) of the external computing entity 102. In various embodiments, the user interface 800 may be provided via the display 316 of the external computing entity 102. The user interface 800 may be configured to render the visualization 706. In various embodiments, the visualization 806 may provide a visualization of a prediction output (e.g., one or more recommendation predictions) for the user interface workflow 404. For example, the visualization 706 may render one or more selectable graphical elements related to the ranked version of the set of recommendation data objects 406′. Additionally, in certain embodiments, the user interface 800 may be configured to render the user interface workflow 404 related to the visualization 706. The user interface workflow 404 may provide textual information and/or visual information related to a questionnaire for a user identifier desiring a particular domain plan (e.g., a particular medical plan). In various embodiments, the user interface 800 may be configured as a web portal interface (e.g., a medical plan decision portal, etc.) for medical plan decision automation related to medical plans.

Another operational example of prediction-based actions that may be performed based on prediction outputs comprise performing operational load balancing for post-prediction systems that perform post-prediction operations (e.g., automated specialist appointment scheduling operations) based on prediction outputs. For example, in some embodiments, a predictive recommendation computing entity determines D classifications for D prediction input data objects based on whether the selected region subset for each prediction input data object as generated by the predictive recommendation model comprises a target region (e.g., a target brain region). Then, the count of D prediction input data objects that are associated with an affirmative classification, along with a resource utilization ratio for each prediction input data object, may be used to predict a predicted number of computing entities needed to perform post-prediction processing operations with respect to the D prediction input data objects. For example, in some embodiments, the number of computing entities needed to perform post-prediction processing operations (e.g., automated specialist scheduling operations) with respect to D prediction input data objects may be determined based on the output of the equation: R=ceil(Σₖ^{k=K} urₖ), where R is the predicted number of computing entities needed to perform post-prediction processing operations with respect to the D prediction input data objects, ceil(.) is a ceiling function that returns the closest integer that is greater than or equal to the value provided as the input parameter of the ceiling function, k is an index variable that iterates over K prediction input data objects among the D prediction input data objects that are associated with affirmative classifications, and urₖ is the estimated resource utilization ratio for a kth prediction input data object that may be determined based on a patient history complexity of a patient associated with the prediction input data object. In some embodiments, once R is generated, a predictive recommendation computing entity may use R to perform operational load balancing for a server system that is configured to perform post-prediction processing operations with respect to D prediction input data objects. This may be done by allocating computing entities to the post-prediction processing operations if the number of currently-allocated computing entities is below R, and deallocating currently-allocated computing entities if the number of currently-allocated computing entities is above R.

### Generating Recommendation Data Objects for a User Interface Using Machine Learning and Rules-Based Logic

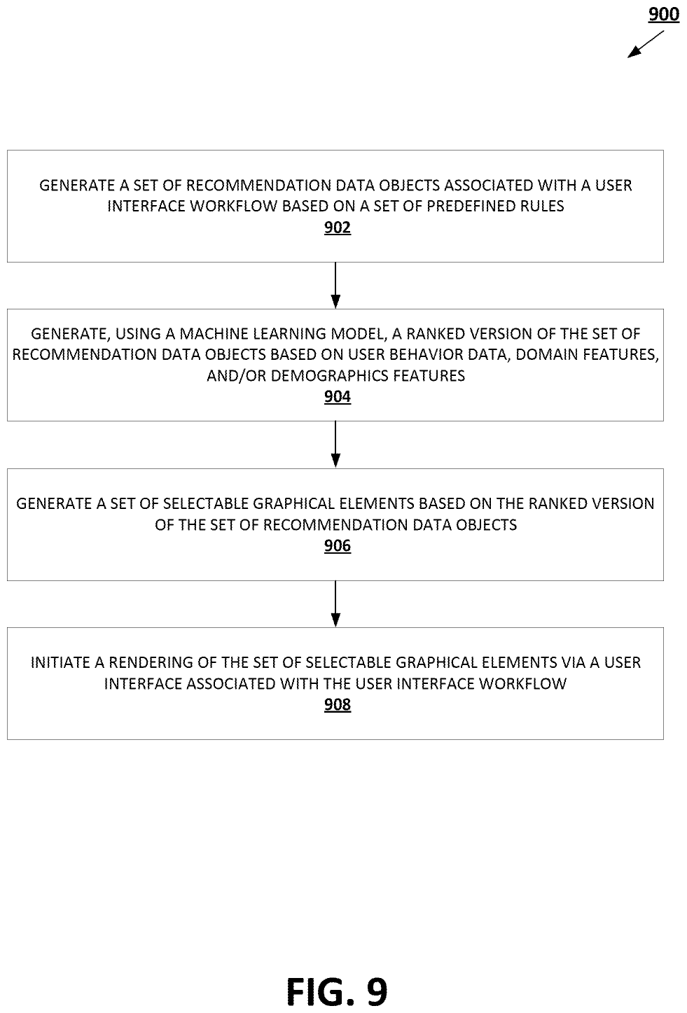

FIG. 9 is a flowchart diagram of an example process 900 for generating recommendation data objects for a user interface using machine learning and rules-based logic, in accordance with one or more embodiments of the present disclosure. Via the various steps/operations of process 900, the machine learning recommendation computing entity 106 may process the source data 122 and/or other data using one or more artificial intelligence techniques (e.g., one or more machine learning techniques) to provide improved prediction output. In doing so, the machine learning recommendation computing entity 106 may utilize machine learning solutions to infer important predictive insights and/or inferences related to data and/or features for recommendations.

The process 900 begins at step/operation 902 when the rules engine 110 of the machine learning recommendation computing entity 106 generates a set of recommendation data objects associated with a user interface workflow based on a set of predefined rules.

At step/operation 904, the machine learning engine 112 of the machine learning recommendation computing entity 106 generates, using a machine learning model, a ranked version of the set of recommendation data objects based on user behavior data, domain features, and/or demographics features.

At step/operation 906, the action engine 114 of the machine learning recommendation computing entity 106 generates a set of selectable graphical elements based on the ranked version of the set of recommendation data objects.

At step/operation 908, the action engine 114 of the machine learning recommendation computing entity 106 initiates a rendering of the set of selectable graphical elements via a user interface associated with the user interface workflow.

As discussed herein, some techniques of the present disclosure enable the generation of new machine learning models with parameters specifically trained and tailored to perform one or more predictive actions to achieve real-world affects. The machine learning models of the present disclosure may be used, applied, and/or otherwise leveraged to generate predictions. These predictions may be leveraged to initiate the performance of various computing tasks that improve the performance of a computing system (e.g., a computer itself, etc.) with respect to various predictive actions performed by the computing system.

In some examples, the computing tasks may include predictive actions that may be based on a prediction domain. A prediction domain may include any environment in which computing systems may be applied to achieve real-word insights, such as predictions, and initiate the performance of computing tasks, such as predictive actions, to act on the real-world insights. These predictive actions may cause real-world changes, for example, by controlling a hardware component, providing targeted alerts, dynamically altering an user interface workflow, dynamically altering a user interface, automatically allocating computing or human resources, and/or the like.

Examples of prediction domains may include financial systems, clinical systems, healthcare systems, autonomous systems, robotic systems, and/or the like. Predictive actions in such domains may include the initiation of automated instructions across and between devices, automated notifications, automated scheduling operations, automated precautionary actions, automated security actions, automated data processing actions, automated server load balancing actions, automated computing resource allocation actions, automated adjustments to computing and/or human resource management, and/or the like.

As one example, a prediction domain may include a clinical prediction domain. In such a case, the predictive actions may include automated physician notification actions, automated patient notification actions, automated appointment scheduling actions, automated prescription recommendation actions, automated record updating actions, automated datastore updating actions, automated workforce management operational management actions, automated server load balancing actions, automated resource allocation actions, automated pricing actions, automated plan update actions, automated alert generation actions, and/or the like.

In some embodiments, the machine learning model executed through the operations of process 900 is applied to initiate the performance of one or more predictive actions. As described herein, the predictive actions may depend on the prediction domain. In some examples, the architecture 100 may leverage the machine learning model to generate a plurality of canonical representations of a plurality of disparate third-party datasets. Using these canonical representations, the architecture 100 may aggregate data across a plurality of third-party data sources to generate predictive insights for a respective prediction domain. These predictive insights may be leveraged to initiate the performance of the one or more predictive actions within the respective prediction domain. By way of example, the prediction domain may include a healthcare plan prediction domain and the one or more predictive actions may include performing a resource-based action (e.g., allocation of resource), generating a recommendation report, generating action scripts, generating alerts or messages, generating one or more electronic communications, and/or the like. The one or more predictive actions may further include displaying visual renderings of the aforementioned examples of predictive actions in addition to values, charts, and representations associated with the third-party data sources and/or third-party datasets thereof. In some embodiments, the visual rendering include the set of selectable graphical elements.

Accordingly, as described above, various embodiments of the present disclosure address technical challenges related to accurately, efficiently, and/or reliably providing recommendations for user interface workflows in a consumable manner. In various embodiments, proposed solutions provide recommendation predictions and/or ranking of predictions using machine learning. In various embodiments, after one or more machine learning models are generated and/or trained, the one or more machine learning models may be utilized to perform accurate, efficient, and reliable recommendation predictions. Accordingly, techniques that improve predictive accuracy without harming training speed, such as various techniques described herein, enable improving training speed given a constant predictive accuracy for recommendations. Therefore, by improving accuracy of performing machine learning predictions, various embodiments of the present disclosure improve the training speed of machine learning frameworks.

### VI. Conclusion

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. Examples

Example 1. A computer-implemented method, the computer-implemented method comprising: generating, by one or more processors, a set of recommendation data objects for a user identifier associated with a user interface based on a set of predefined rules associated with input data provided via a user interface workflow associated with the user interface; generating, by the one or more processors and using a machine learning model, a ranked version of the set of recommendation data objects based on (i) the input data, (ii) a user behavior data associated with the user identifier, and (iii) a domain features set associated with respective domain classifications for the set of recommendation data objects; and initiating, by the one or more processors and via the user interface, a rendering of a set of selectable graphical elements based on the ranked version of the set of recommendation data objects.

Example 2. The computer-implemented method any of the preceding examples, wherein generating the ranked version of the set of recommendation data objects comprises: applying learning-to-rank machine learning to (i) the input data, (ii) the user behavior data, and (iii) the domain features set to generate the ranked version of the set of recommendation data objects.

Example 3. The computer-implemented method any of the preceding examples, wherein generating the ranked version of the set of recommendation data objects comprises: generating, using the machine learning model, the ranked version of the set of recommendation data objects based on (i) the input data, (ii) the user behavior data, (iii) the domain features set, and (iv) a demographics features set associated with the input data.

Example 4. The computer-implemented method any of the preceding examples, further comprising: receiving the user behavior data from a third-party data source; transforming the user behavior data into a user behavior features set; and applying the machine learning model to the user behavior features set.

Example 5. The computer-implemented method any of the preceding examples, wherein the user behavior data comprises a set of binary encodings for particular attributes related to one or more different user interface workflows associated with the user identifier, and wherein generating the ranked version of the set of recommendation data objects comprises: applying the machine learning model to the set of binary encodings.

Example 6. The computer-implemented method any of the preceding examples, wherein the user behavior data comprises website activity data associated with the user identifier, and wherein generating the ranked version of the set of recommendation data objects comprises: applying the machine learning model to the website activity data.

Example 7. The computer-implemented method any of the preceding examples, wherein initiating the rendering of the set of selectable graphical elements comprises: transmitting the ranked version of the set of recommendation data objects to an application programming interface (API) associated with the user interface.

Example 8. A computing system comprising memory and one or more processors communicatively coupled to the memory, the one or more processors configured to: generate a set of recommendation data objects for a user identifier associated with a user interface based on a set of predefined rules associated with input data provided via a user interface workflow associated with the user interface; generate, using a machine learning model, a ranked version of the set of recommendation data objects based on (i) the input data, (ii) a user behavior data associated with the user identifier, and (iii) a domain features set associated with respective domain classifications for the set of recommendation data objects; and initiate, via the user interface, a rendering of a set of selectable graphical elements based on the ranked version of the set of recommendation data objects.

Example 9. The computing system of any of the preceding examples, the one or more processors further configured to: apply learning-to-rank machine learning to (i) the input data, (ii) the user behavior data, and (iii) the domain features set to generate the ranked version of the set of recommendation data objects.

Example 10. The computing system of any of the preceding examples, the one or more processors further configured to: generate, using the machine learning model, the ranked version of the set of recommendation data objects based on (i) the input data, (ii) the user behavior data, (iii) the domain features set, and (iv) a demographics features set associated with the input data.

Example 11. The computing system of any of the preceding examples, the one or more processors further configured to: receive the user behavior data from a third-party data source; transform the user behavior data into a user behavior features set; and apply the machine learning model to the user behavior features set.

Example 12. The computing system of any of the preceding examples, wherein the user behavior data comprises a set of binary encodings for particular attributes related to one or more different user interface workflows associated with the user identifier, and the one or more processors further configured to: apply the machine learning model to the set of binary encodings.

Example 13. The computing system of any of the preceding examples, wherein the user behavior data comprises website activity data associated with the user identifier, and the one or more processors further configured to: apply the machine learning model to the website activity data.

Example 14. The computing system of any of the preceding examples, the one or more processors further configured to: transmit the ranked version of the set of recommendation data objects to an application programming interface (API) associated with the user interface.

Example 15. One or more non-transitory computer-readable storage media including instructions that, when executed by one or more processors, cause the one or more processors to: generate a set of recommendation data objects for a user identifier associated with a user interface based on a set of predefined rules associated with input data provided via a user interface workflow associated with the user interface; generate, using a machine learning model, a ranked version of the set of recommendation data objects based on (i) the input data, (ii) a user behavior data associated with the user identifier, and (iii) a domain features set associated with respective domain classifications for the set of recommendation data objects; and initiate, via the user interface, a rendering of a set of selectable graphical elements based on the ranked version of the set of recommendation data objects.

Example 16. The one or more non-transitory computer-readable storage media any of the preceding examples, wherein the one or more processors are further caused to: apply learning-to-rank machine learning to (i) the input data, (ii) the user behavior data, and (iii) the domain features set to generate the ranked version of the set of recommendation data objects.

Example 17. The one or more non-transitory computer-readable storage media any of the preceding examples, wherein the one or more processors are further caused to: generate, using the machine learning model, the ranked version of the set of recommendation data objects based on (i) the input data, (ii) the user behavior data, (iii) the domain features set, and (iv) a demographics features set associated with the input data.

Example 18. The one or more non-transitory computer-readable storage media of any of the preceding examples, wherein the one or more processors are further caused to: receive the user behavior data from a third-party data source; transform the user behavior data into a user behavior features set; and apply the machine learning model to the user behavior features set.

Example 19. The one or more non-transitory computer-readable storage media of any of the preceding examples, wherein the user behavior data comprises a set of binary encodings for particular attributes related to one or more different user interface workflows associated with the user identifier, and the one or more processors are further caused to: apply the machine learning model to the set of binary encodings.

Example 20. The one or more non-transitory computer-readable storage media of any of the preceding examples, wherein the user behavior data comprises website activity data associated with the user identifier, and the one or more processors are further caused to: apply the machine learning model to the website activity data.

1. A computer-implemented method, the computer-implemented method comprising:
generating, by one or more processors, a set of recommendation data objects for a user identifier associated with a user interface based on a set of predefined rules associated with input data provided via a user interface workflow associated with the user interface;
generating, by the one or more processors and using a machine learning model, a ranked version of the set of recommendation data objects based on (i) the input data, (ii) a user behavior data associated with the user identifier, and (iii) a domain features set associated with respective domain classifications for the set of recommendation data objects; and
initiating, by the one or more processors and via the user interface, a rendering of a set of selectable graphical elements based on the ranked version of the set of recommendation data objects.

2. The computer-implemented method of claim 1, wherein generating the ranked version of the set of recommendation data objects comprises:
applying learning-to-rank machine learning to (i) the input data, (ii) the user behavior data, and (iii) the domain features set to generate the ranked version of the set of recommendation data objects.

3. The computer-implemented method of claim 1, wherein generating the ranked version of the set of recommendation data objects comprises:
generating, using the machine learning model, the ranked version of the set of recommendation data objects based on (i) the input data, (ii) the user behavior data, (iii) the domain features set, and (iv) a demographics features set associated with the input data.

4. The computer-implemented method of claim 1, further comprising:
receiving the user behavior data from a third-party data source;
transforming the user behavior data into a user behavior features set; and
applying the machine learning model to the user behavior features set.

5. The computer-implemented method of claim 1, wherein the user behavior data comprises a set of binary encodings for particular attributes related to one or more different user interface workflows associated with the user identifier, and wherein generating the ranked version of the set of recommendation data objects comprises:
applying the machine learning model to the set of binary encodings.

6. The computer-implemented method of claim 1, wherein the user behavior data comprises website activity data associated with the user identifier, and wherein generating the ranked version of the set of recommendation data objects comprises:
applying the machine learning model to the website activity data.

7. The computer-implemented method of claim 1, wherein initiating the rendering of the set of selectable graphical elements comprises:
transmitting the ranked version of the set of recommendation data objects to an application programming interface (API) associated with the user interface.

8. A computing system comprising memory and one or more processors communicatively coupled to the memory, the one or more processors configured to:
generate a set of recommendation data objects for a user identifier associated with a user interface based on a set of predefined rules associated with input data provided via a user interface workflow associated with the user interface;
generate, using a machine learning model, a ranked version of the set of recommendation data objects based on (i) the input data, (ii) a user behavior data associated with the user identifier, and (iii) a domain features set associated with respective domain classifications for the set of recommendation data objects; and
initiate, via the user interface, a rendering of a set of selectable graphical elements based on the ranked version of the set of recommendation data objects.

9. The computing system of claim 8, the one or more processors further configured to:
apply learning-to-rank machine learning to (i) the input data, (ii) the user behavior data, and (iii) the domain features set to generate the ranked version of the set of recommendation data objects.

10. The computing system of claim 8, the one or more processors further configured to:
generate, using the machine learning model, the ranked version of the set of recommendation data objects based on (i) the input data, (ii) the user behavior data, (iii) the domain features set, and (iv) a demographics features set associated with the input data.

11. The computing system of claim 8, the one or more processors further configured to:
receive the user behavior data from a third-party data source;
transform the user behavior data into a user behavior features set; and
apply the machine learning model to the user behavior features set.

12. The computing system of claim 8, wherein the user behavior data comprises a set of binary encodings for particular attributes related to one or more different user interface workflows associated with the user identifier, and the one or more processors further configured to:
apply the machine learning model to the set of binary encodings.

13. The computing system of claim 8, wherein the user behavior data comprises website activity data associated with the user identifier, and the one or more processors further configured to:
apply the machine learning model to the website activity data.

14. The computing system of claim 8, the one or more processors further configured to:
transmit the ranked version of the set of recommendation data objects to an application programming interface (API) associated with the user interface.

15. One or more non-transitory computer-readable storage media including instructions that, when executed by one or more processors, cause the one or more processors to:
generate a set of recommendation data objects for a user identifier associated with a user interface based on a set of predefined rules associated with input data provided via a user interface workflow associated with the user interface;
generate, using a machine learning model, a ranked version of the set of recommendation data objects based on (i) the input data, (ii) a user behavior data associated with the user identifier, and (iii) a domain features set associated with respective domain classifications for the set of recommendation data objects; and
initiate, via the user interface, a rendering of a set of selectable graphical elements based on the ranked version of the set of recommendation data objects.

16. The one or more non-transitory computer-readable storage media of claim 15, wherein the one or more processors are further caused to:
apply learning-to-rank machine learning to (i) the input data, (ii) the user behavior data, and (iii) the domain features set to generate the ranked version of the set of recommendation data objects.

17. The one or more non-transitory computer-readable storage media of claim 15, wherein the one or more processors are further caused to:
generate, using the machine learning model, the ranked version of the set of recommendation data objects based on (i) the input data, (ii) the user behavior data, (iii) the domain features set, and (iv) a demographics features set associated with the input data.

18. The one or more non-transitory computer-readable storage media of claim 15, wherein the one or more processors are further caused to:
receive the user behavior data from a third-party data source;
transform the user behavior data into a user behavior features set; and
apply the machine learning model to the user behavior features set.

19. The one or more non-transitory computer-readable storage media of claim 15, wherein the user behavior data comprises a set of binary encodings for particular attributes related to one or more different user interface workflows associated with the user identifier, and the one or more processors are further caused to:
apply the machine learning model to the set of binary encodings.

20. The one or more non-transitory computer-readable storage media of claim 15, wherein the user behavior data comprises website activity data associated with the user identifier, and the one or more processors are further caused to:
apply the machine learning model to the website activity data.
